(19) United States
(12) Patent Application Publication
(10) Pub. No.: US 2002/0105725 A1
(43) Pub. Date: Aug. 8, 2002

(54) Electrically-programmable optical processor with enhanced resolution

(76) Inventors: William C. Sweatt, Albuquerque, NM (US); Michael B. Sinclair, Albuquerque, NM (US); Michael A. Butler, Albuquerque, NM (US)

Correspondence Address: SANDIA NATIONAL LABORATORIES, Patent & Licensing Center, P.O. Box 5800 - MS-0161, Albuquerque, NM, 87185-0161, US

(21) Appl. No.: 09/740,324

(22) Filed: Dec. 18, 2000

(51) Int. Cl. G02F 1/13

(52) U.S. Cl. 359/566; 349/201

(57) ABSTRACT

An optical apparatus is disclosed for processing light that based on a pair of diffraction gratings operating in tandem, with one of the gratings being a fixed diffraction grating and with the other grating being electrically programmable. The combination of the fixed and electrically-programmable diffraction gratings provides a spectral resolution and dispersion higher than that of either diffraction grating when used alone. These two diffraction gratings can be formed on different substrates, or alternately be combined to form a composite diffraction grating. The electrically-programmable diffraction grating can be operated in either a singly-periodic mode or a multi-periodic mode to select particular wavelengths of the incident light for analysis and detection, or for transferring between optical fibers (e.g. wavelength division multiplexing or demultiplexing). In some cases, a prism can be substituted for the fixed diffraction grating or used in addition to the fixed grating. The optical apparatus has applications for use in remote spectral analysis, spectrometry, and optical fiber communications.

### GOVERNMENT RIGHTS

This invention was made with Government support under Contract No. DE-AC04-94AL85000 awarded by the U.S. Department of Energy. The Government has certain rights in the invention.

### FIELD OF THE INVENTION

The present invention relates to diffraction gratings and to optical signal processors based on diffraction gratings for applications including spectrometry, optical communications, optical computing, optical modulation and optical correlation.

### BACKGROUND OF THE INVENTION

Electrically-programmable diffraction gratings fabricated by microelectromechanical systems (MEMS) technology have been disclosed in U.S. Pat. Nos. 5,757,536 to Ricco et al, 5,905,571 to Butler et al and 5,999,319 to Castracane. These electrically-programmable diffraction gratings utilize electrostatically moveable grating elements with flat (i.e. planar) light-reflective surfaces to diffract light, with the exact diffraction characteristics depending upon a vertical spaced relationship of the various grating elements. The resolving power of such programmable gratings is defined by the number of grating elements and by the spacing between adjacent grating elements, both of which are determined at the point of manufacture. The fabrication of an electrically-programmable diffraction grating having a large number of grating elements is presently difficult since complexity of the device increases and manufacturing yield decreases as the number of grating elements is increased. Therefore, the resolving power of current electrically-programmable diffraction gratings is limited; and this, in turn, limits the applications for such programmable gratings. For many potential applications (e.g. spectral analysis for astronomy), current programmable diffraction gratings are not suitable due to their limited resolving power. What is needed is a way to increase the resolving power and utility of an electrically-programmable diffraction grating having a relatively small number of grating elements therein (e.g. ≦100 mm⁻¹).

The present invention provides a solution to this problem by providing an optical apparatus having a fixed diffraction grating that operates in tandem with an electrically-programmable diffraction grating, thereby increasing the resolution and utility of the electrically-programmable diffraction grating.

An advantage of the present invention is that the resolving power and utility of an electrically-programmable diffraction grating having a relatively low number of grating elements (e.g. ≦100 mm⁻¹) can be enhanced by pairing the electrically-programmable diffraction grating with a fixed diffraction grating having at least as many grating elements, and preferably a larger number of grating elements.

Another advantage of the present invention is that the electrically-programmable diffraction grating and the fixed diffraction grating can be formed on different substrates to allow the insertion of optical elements (e.g. lenses and stops) between the gratings. Alternately, the electrically-programmable diffraction grating and the fixed diffraction grating can be combined on a common substrate to form a composite diffraction grating.

These and other advantages of the present invention will become evident to those skilled in the art.

### SUMMARY OF THE INVENTION

The present invention relates to an optical apparatus for processing light, with the apparatus comprising a pair of diffraction gratings that operate in tandem. The pair of diffraction gratings include a first diffraction grating having a first plurality of grating elements with a fixed spaced relationship therebetween, and a second diffraction grating having a second plurality of grating elements with an electrically-variable spaced relationship therebetween. One of the pair of diffraction gratings initially intercepts and processes the light and then directs the light to the other diffraction grating for further processing.

The number of grating elements in the first plurality of grating elements will, in general, depend upon a particular application of the optical apparatus and can be different from the number of grating elements in the second plurality of grating elements. Similarly, the spacing between adjacent grating elements in the first plurality of grating elements can be different from the spacing between adjacent grating elements in the second plurality of grating elements. The first diffraction grating can comprise, for example, a replicated, ruled or holographic diffraction grating.

The second diffraction grating comprises an electrically-programmable diffraction grating in which the spaced relationship of the second plurality of grating elements can be varied in response to at least one electrical signal provided thereto (e.g. from a microprocessor or computer). Each grating element in the second plurality of grating elements comprises an elongate moveable electrode elastically supported above an elongate stationary electrode to permit the spaced relationship of the grating element to be varied relative to an adjacent grating element in the second plurality of grating elements in response to an electrical signal applied between the stationary and moveable electrodes. The electrically-variable spaced relationship of the second periodicity of grating elements can be either a singly-periodic spaced relationship or a multiply-periodic spaced relationship.

The first and second diffraction gratings can be formed on separate substrates (e.g. the first diffraction grating can be formed on a glass, fused silica, ceramic, silicon or metal substrate, and the second diffraction grating can be formed on a silicon substrate). This allows the first and second diffraction gratings to be oriented at an angle with respect to each other.

In the optical apparatus, a lens or telescope can be provided for receiving the incident light to be processed and for directing the light onto the diffraction grating which initially intercepts and processes the light. A detector can also be provided for receiving the processed light and generating an output signal therefrom. Furthermore, a telescope can be located in a path of the light between the two diffraction gratings to substantially image the surface of one of the diffraction gratings onto the surface of the other diffraction grating. In some cases, an optical stop can also be located between the first and second diffraction gratings to further process the light by eliminating an unwanted component of the light.

In certain embodiments of the present invention, light received from at least one input optical fiber can be processed by the apparatus, with at least a portion of the received light being processed and directed to at least one output optical fiber. Such embodiments of the present invention have applications for wavelength division multiplexing and demultiplexing.

The present invention further relates to an optical apparatus for processing light, comprising a first substrate having a fixed diffraction grating formed thereon with a plurality of fixed grating elements, and a second substrate located proximate to the first substrate and having an electrically-programmable diffraction grating formed thereon, with the electrically-programmable diffraction grating further comprising a plurality of moveable grating elements, with each moveable grating element being elongate and elastically mounted for movement relative to an adjacent grating element in response to a voltage applied between the grating element and an electrode formed proximate thereto. The fixed and electrically-programmable diffraction gratings operate in combination to sequentially process the light.

As previously mentioned, the fixed diffraction grating can comprise a replicated or ruled diffraction grating; and the fixed and electrically-programmable diffraction gratings can have a different number of grating elements therein or a different spacing between adjacent grating elements. The two diffraction gratings can be formed on different substrates, with each substrate comprising a different substrate material. A lens or telescope can be provided for receiving the light to be processed and directing the light onto the diffraction grating which is to initially process the light. A telescope can also be located in a path of the light between the two diffraction gratings; and an optical stop can be located between the two diffraction gratings to further process the light by eliminating an unwanted component of the light.

The processed light can be sent to a detector that generates an output signal in response to the processed light. In some cases, the apparatus can be used to process light received from at least one input optical fiber and direct a portion or all of the processed light to at least one output optical fiber.

The present invention also relates to an optical apparatus for processing light, comprising a composite diffraction grating formed on a substrate (e.g. comprising silicon) and having a first plurality of grating elements with an electrically-variable spaced relationship between adjacent grating elements of the first plurality of grating elements, and with each grating element in the first plurality of grating elements further having formed thereon a second plurality of grating elements in a fixed spaced relationship between adjacent grating elements of the second plurality of grating elements. A portion or all of the first plurality of grating elements can be moveable in a direction perpendicular to the substrate, or parallel to the substrate or a combination thereof for defining the electrically-variable spaced relationship between adjacent of the grating elements in the first plurality of grating elements. A lens or telescope can be used in the apparatus for receiving the light and directing the light onto the composite diffraction grating; and a detector can be used for receiving the processed light and generating an output signal therefrom. In some cases, the composite diffraction grating can be used to process light received from one or more input optical fibers, and direct at least a portion of the received light to one or more output optical fibers after processing thereof.

The present invention further relates to a method for increasing the wavelength resolution of an electrically-programmable diffraction grating, comprising introducing a wavelength dispersing element into an optical path of the electrically-programmable diffraction grating. The wavelength dispersing element can comprise a prism or fixed diffraction grating.

Finally, the present invention relates to a method for processing light comprising steps for directing the light to a first diffraction grating for initial processing of the light by selecting a wavelength range of interest; and directing the light to a second diffraction grating for subsequent processing of the light by selecting at least one wavelength within the wavelength range of interest, with one of the first and second diffraction gratings having a fixed spaced relationship of grating elements therein, and with the other diffraction grating having an electrically-variable spaced relationship of grating elements therein.

Additional advantages and novel features of the invention will become apparent to those skilled in the art upon examination of the following detailed description thereof when considered in conjunction with the accompanying drawings. The advantages of the invention can be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several aspects of the present invention and, together with the description, serve to explain the principles of the invention. The drawings are only for the purpose of illustrating preferred embodiments of the invention and are not to be construed as limiting the invention. In the drawings:

FIG. 1 shows a schematic diagram of a first embodiment of the present invention.

FIG. 2 shows a schematic diagram of a second embodiment of the present invention.

FIG. 3 shows a schematic diagram of a third embodiment of the present invention.

FIG. 4 shows a schematic cross-section view of an electrically-programmable diffraction grating operating in a multiperiodic mode.

FIG. 5 shows a schematic diagram of a fourth embodiment of the present invention.

FIG. 6 shows the dependence of the detected wavelength of light on the spatial frequency of the electrically-programmable diffraction grating for the apparatus of FIG. 5. The open circles are measured data points, and the solid line is the calculated dependence.

FIG. 7 shows another possible arrangement for the apparatus of FIG. 5.

FIG. 8 shows a schematic diagram of a fifth embodiment of the present invention.

FIG. 9A shows a schematic plan view of a composite diffraction grating used in the fifth embodiment of the present invention in FIG. 8.

FIG. 9B shows a schematic cross-section view of the composite diffraction grating of FIG. 9A along the section line 1-1.

FIG. 9C illustrates a first mode of operation of the composite diffraction grating of FIGS. 9A and 9B.

FIGS. 10A -10F. schematically illustrate a series of steps for fabricating the composite diffraction grating of FIGS. 9A and 9B.

### DETAILED DESCRIPTION OF THE INVENTION

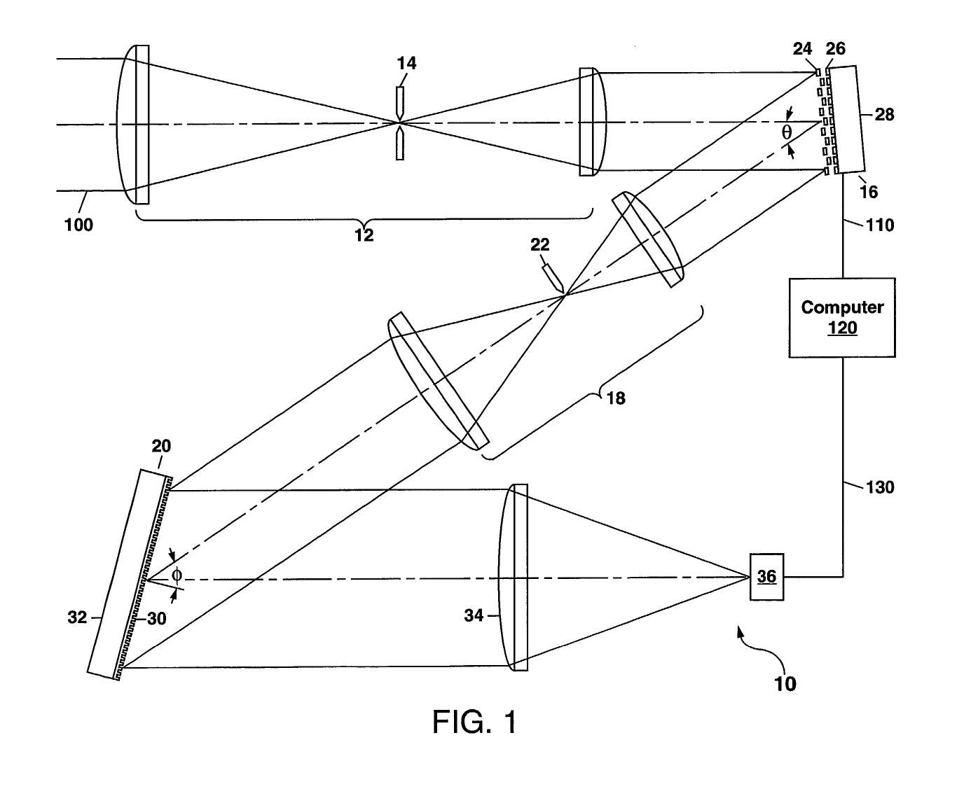

Referring to FIG. 1, there is shown a schematic diagram of a first embodiment of the optical apparatus 10 of the present invention. This embodiment of the present invention can be used, for example, for remote spectral analysis of absorption or emission in a vapor plume (not shown). Additionally, this embodiment of the apparatus 10 can be used in astronomy to analyze absorption or emission from outer space (e.g. from planets, stars, galaxies, interstellar gas, etc.).

In FIG. 1, light 100 (e.g. reflected or scattered sunlight) from a remote region of interest having been partially absorbed by or scattered from the vapor plume to encode spectral information about the vapor plume in the spectrum of the light 100 enters the apparatus 10 through a telescope 12. The telescope 12 can include a pinhole or slit 14 at a focal point therein to produce a small, compact source of light, thereby allowing desired spectral components or portions of the light 100 to be separated from unwanted portions in the apparatus 10 so that only the desired spectral components or portions of the light 100 are directed through the apparatus 10 to a detector 36 or alternately to one or more optical fibers 40. The telescope collects the light 100 which is then approximately collimated and directed onto an electrically-programmable diffraction grating 16. The grating 16 in an electrically-unprogrammed state (i.e. with no voltages provided to the grating 16 so that all the grating elements 24 are coplanar) is oriented to reflect the longest wavelength of interest through another telescope 18 and approximately image the light 100 onto a fixed diffraction grating 20 which further diffracts this wavelength of the light 100 for detection at the detector 36. Other wavelengths of interest that are shorter than the longest wavelength of interest can be diffracted from the electrically-programmable diffraction grating 16 onto the fixed diffraction grating 20 when the grating elements 24 are non-coplanar (i.e. when particular programming voltages 110 from a microprocessor or computer 120 are provided to the grating elements 24), with these two gratings 16 and 20 acting in combination to direct these other wavelengths to the detector 36. Approximate imaging of one grating 16 or 20 onto the other grating 20 or 16 is important to increase the light throughput in the apparatus 10.

In FIG. 1, the telescope 18 magnifies a portion of the light 100 containing the encoded spectral information (i.e. the various wavelengths of interest and any modulation in amplitude or frequency thereof) to illuminate the surface of a fixed diffraction grating 20. The light 100 reflected or diffracted from the surface of the electrically-programmable diffraction grating 16 is preferably collimated and imaged onto the surface of the fixed diffraction grating 20 by the telescope 18 with appropriate magnification or demagnification, and with the grating elements 24 and 30 of the respective diffraction gratings 16 and 20 being aligned parallel to each other. An optical stop 22 (e.g. a knife edge, slit or pinhole) can be provided at a focal point within the second telescope 18 to reject components of the light 100 diffracted from the grating 16 that do not include the wavelengths of interest, or that include any diffraction order higher than the first order. In this way, only the reflected or first-order diffracted light of the wavelengths of interest is directed through the telescope 18 to the grating 20 for further processing.

The electrically-programmable diffraction grating 16 has a plurality of elongate (e.g. rectangular) grating elements 24 which are oriented with their longitudinal axis normal to the plane of the drawing in FIG. 1. These grating elements 24, which can be, for example, 10-100 μm wide and 0.1-10 mm long, form moveable electrodes, with each grating element 24 being elastically supported above one or more elongate stationary electrodes 26 that underlie each grating element 24. This allows each grating element 24 to be electrostatically moveable in a direction perpendicular to the surface of a substrate 28 (e.g. comprising silicon) whereon the grating element 24 is formed in response to an electrical programming signal 110 applied between the grating element 24 and its associated stationary electrode(s) 26. Thus, a vertical spaced relationship between a plurality of adjacent grating elements 24 can be defined and varied in response to electrical programming signals 110 (i.e. voltages) provided to the individual grating elements 24, or to sets of the grating elements 24. By selecting the electrical signals provided to the electrically-programmable diffraction grating 16, particular wavelengths of interest can be directed through the telescope 18 to the fixed diffraction grating 20 for further processing.

For many applications, the utility of the electrically-programmable diffraction grating 16 is limited since it has insufficient spectral resolution to resolve individual spectral features from the wavelengths of interest of the light 100 to recover the encoded information. A solution to this problem is provided by the present invention wherein a fixed diffraction grating 20 is provided to act in combination with the electrically-programmable diffraction grating 16 thereby increasing the spectral resolution and permitting recovery of encoded information from the incident light 100 which would otherwise not be recoverable. In certain situations, other types of dispersive optical elements (e.g. a prism) can be substituted for the fixed diffraction grating 20 according to the present invention, or used in addition to the fixed grating 20.

The relatively low spectral resolution of the electrically-programmable diffraction grating 16 is a result of the current state of surface micromachining which limits the density of grating elements 24 to on the order of 100 elements/mm or less. This is due in part by a need for the grating elements 24 to be rigid and provide a coplanar surface for the diffraction of light while preventing vertical or horizontal bowing of the elements 24.

In contrast, conventional diffraction gratings which have a fixed number and spaced arrangement of grating elements (i.e.grooves) are formed by replication from a master grating, by ruling a reflective metal coating deposited on a substrate, or by laser holographic exposure of a photographic emulsion. These fixed diffraction gratings can have from a few hundred grooves/mm (i.e. lines/mm) up to more than a thousand grooves/mm.

Since the angular dispersion, Δθ/Δλ, of a diffraction grating with respect to wavelength, λ, is directly related to the spatial frequency, 1/d, of the grating, then an electrically-programmable diffraction grating 16 having a relatively low density of grating elements 24 (i.e. a relatively large spacing, d, between adjacent grating elements 24) will exhibit a relatively low angular dispersion. As a result, the ability of this grating 16 to resolve closely spaced wavelengths of light will be limited. This limited resolution limits the utility of the electrically-programmable diffraction grating 16 for many applications unless it is operated according to the present invention in tandem with a fixed diffraction grating 20 to increase the overall resolution.

In the example of the present invention in FIG. 1, the fixed diffraction grating 20 comprises a conventional diffraction grating formed, for example, on a substrate 32 (e.g. comprising glass, fused silica, ceramic, silicon, metal or any other material whereon conventional diffraction gratings are formed) by ruling, replication or holography. The fixed diffraction grating 20 includes a plurality of grating elements in the form of grooves 30 with a fixed spaced relationship with respect to each other. The size of the fixed diffraction grating 20 can be, for example, 1-4 inches square or in diameter; and the number of grating elements 30 can be, for example, 100-1200 grooves/mm. The fixed diffraction grating 20 can be either blazed at a predetermined angle for increased diffraction efficiency, or unblazed.

The term “fixed spaced relationship” as used herein refers to the size, shape and orientation of the grating elements 30 (also termed grooves, lines or ruling) relative to the surface of the substrate 32 on which the grating elements 30 are formed. The size, shape and orientation (also termed blaze angle) of the grating elements 30 are defined during manufacture of the grating 20 by replication, ruling or holography, and cannot be subsequently altered.

Although the grating elements 30 are fixed, the entire diffraction grating 20 can be oriented at an arbitrary angle, φ, to the incident light 100 as shown in FIG. 1 to select a particular wavelength of the light 100 to be diffracted from the grating 20 and directed through a focusing lens 34 to a detector 36. For example, when no programming voltage signals are applied to the electrically-programmable diffraction grating 16, the angle, φ, can be set to correspond to the longest wavelength of interest. Under this condition, all the grating elements 24 are coplanar so that the grating 16 simply functions as a mirror to reflect the light 100 through the telescope 18 and onto the fixed diffraction grating 20 with the selected wavelength (e.g. the longest wavelength of interest) being determined by diffraction from the fixed grating 20. In the apparatus 10, shorter wavelengths of interest can also be directed to the detector 36 in response to particular programming voltages 110 provided to the electrically-programmable diffraction grating 16. These shorter wavelengths of interest will generally propagate through the apparatus 10 to the detector 36 at angles that are slightly different from θ and φ. In this way, the apparatus 10 can be used to process the light 100 and select a range of wavelengths corresponding to light absorption or emission by one or more molecular species to be detected and analyzed with the apparatus 10. The wavelengths of interest for the apparatus 10 are generally in the range of 0.3-20 μm, with the exact range of interest depending upon a particular application (e.g. 1.3-1.6 μm for optical fiber communications, or 3-5 μm for the remote detection of particular chemical species).

In FIG. 1, by electrically programming the grating 16 to provide various operating voltages 110 between the grating elements 24 and the stationary electrodes 26, a predetermined spaced relationship between the grating elements 24 can be formed and varied so that the wavelength of the detected light 100 can be varied. As the spaced relationship between the grating elements 26 is varied, different wavelengths in the wavelength range of interest can be sequentially provided to the detector 36 to generate an electrical output signal 130 containing the information encoded within the light 100.

In one mode of operation of the device 10, the spaced relationship of the grating elements 24 can be varied in a continuous or stepwise manner with time to scan across the wavelength range of interest thereby forming a scanning spectrometer. This can be done, for example, by electrically actuating every other grating element 24, every other pair of grating elements 24, every other set of three grating elements 24, etc. Other arrangements for continuously or stepwise scanning across the wavelength range of interest are possible.

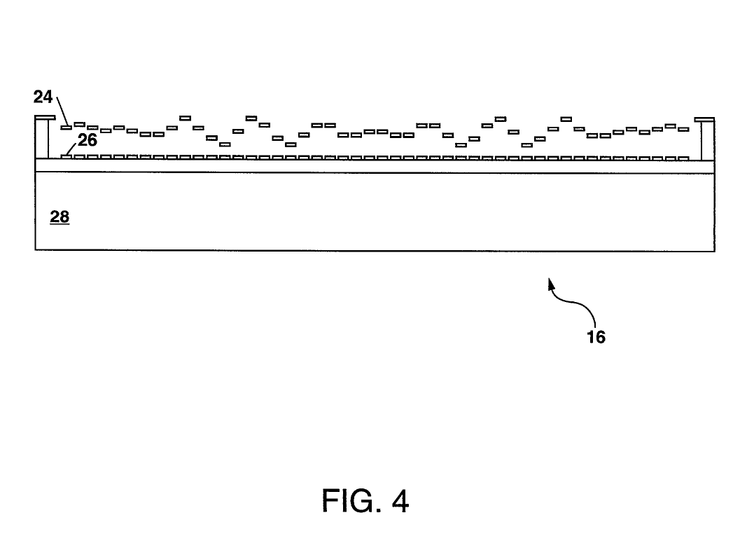

Alternately, a plurality of wavelengths of interest can be simultaneously processed and detected with the apparatus 10 by forming a multiperiodic spaced relationship of the grating elements 24 as shown, for example, in FIG. 4. In FIG. 4, the vertical movement of the individual grating elements 24 varies across the width of the device 10 with an envelope that is the superposition of two spatial frequencies. A multiperiodic spaced relationship of the grating elements 24 is useful for diffracting two different wavelengths of light, λ₁ and λ₂, at the same angle so that these two wavelengths of the light can be further processed by the fixed diffraction grating 20 and then simultaneously detected by the detector 36, which can either be a single-element detector or an array detector (i.e. a plurality of detector elements arranged in an array).

Multiperiodic operation of an electrically-programmable diffraction grating is disclosed in U.S. Pat. No. 5,905,571, which is incorporated herein by reference. Such multiperiodic operation is useful, for example, for operating the apparatus 10 as a correlation spectrometer to simultaneously detect a number of wavelengths of interest in the incident light 100.

The combination of a fixed diffraction grating 20 and an electrically-programmable diffraction grating 16 as disclosed according to the present invention is advantageous since the fixed diffraction grating 20 can be used to enhance the spectral resolution and utility of the electrically-programmable diffraction grating 16 without requiring that the two diffraction gratings be matched in size or number of grating elements, or without requiring that the two diffraction gratings be scanned in unison. The fixed diffraction grating 20 preferably has at least as many grating elements as the programmable grating 16, with the number of grating elements 30 in the fixed grating 20 generally being up to about ten times the number of grating elements 24 in the electrically-programmable diffraction grating 16. These additional grating elements 30 in the fixed diffraction grating 20 enhance the resolution of the device 10 over that which would be possible with the electrically-programmable diffraction grating 16 used alone. Furthermore, the two diffraction gratings 16 and 20 need not track each other by being scanned in unison since one diffraction grating (i.e. grating 20) is generally fixed in position (i.e. at a fixed angle φ) during use, and the other diffraction grating (i.e. grating 16) is electrically varied or scanned.

To access different wavelength ranges of interest or to change the spectral resolution of the apparatus 10, different fixed diffraction gratings 20 can be substituted into the apparatus 10 as needed prior to use of the apparatus 10. The maximum spectral resolution, Δλ, of the apparatus 10 at a particular wavelength of interest, Δλ, is given by:

$$Δ λ = \frac{λ}{( n + m )}$$

where n is the maximum number of lines in the programmable diffraction grating 16 (n is equal to one-half the total number of grating elements 24 when the grating 16 is configured as shown in FIG. 1), and m is the number of lines in the fixed diffraction grating 20 (m is equal to the number of grating elements 30, with each grating element 30 being defined as a light-diffracting element such as a groove or line formed in the surface of the substrate 32).

In the above equation, the number of lines in each diffraction grating 16 and 20 are additive so that the resolution is defined by the total number of lines, m+n. This allows a trade-off between the two gratings 16 and 20 so that the electrically-programmable diffraction grating 16 can have a relatively low total number (e.g. 50/mm) of grating elements 24 while the fixed diffraction grating 20 can have a much larger total number (e.g. 500/mm) of grating elements 30. The combination of diffraction gratings 16 and 20 in the apparatus 10 in this example can provide a maximum spectral resolution, A, that is an order of magnitude larger than the resolution which could be achieved with the programmable diffraction grating 16 alone.

In FIG. 1, the detector 36 can be a photoelectric detector (e.g. a photomultiplier tube), a semiconductor detector, a pyroelectric detector, or a thermal detector. Suitable semiconductor detectors 36 for use with the present invention can include single element or array detectors comprising silicon, germanium, gallium arsenide, indium arsenide, indium gallium arsenide, indium antimonide, lead sulfide, lead selenide, or mercury cadmium telluride. The selection of a particular detector 36 will generally depend upon a particular wavelength range of interest and the detector sensitivity. The detector output signal 130 can be sent to the microprocessor or computer 120 for analysis or display. A slit or pinhole can be optionally located directly in front of the detector 36, if necessary, to reduce stray light and thereby improve detectivity.

The entire apparatus 10 can be located within a light-tight housing (not shown) with a single entrance port for admitting the light 100 and an optional exit port located immediately in front of the detector 36. In other embodiments of the present invention, reflective optics (e.g. off-axis paraboloid mirrors) can be substituted for the various lenses shown in FIG. 1 (i.e. the focusing lens 34 and the lenses in the telescopes 12 and 18). And in yet other embodiments of the present invention, the locations of the electrically-programmable diffraction grating 16 and the fixed diffraction grating 20 can be switched so that the fixed diffraction grating 20 initially processes the light 100 and the electrically-programmable diffraction grating 16 provides further processing of the light 100. If this is done, the telescope 18 in FIG. 1 can also be inverted, if needed, in order to approximately image the surface of the fixed diffraction grating 20 onto the surface of the electrically-programmable diffraction grating 16 to account for the different sizes of the two diffraction gratings, 16 and 20. Such imaging can be advantageous for optimizing the performance and throughput of the apparatus 10. Finally, in some embodiments of the present invention, a beamsplitter can be inserted into the path of the light 100 before the electrically-programmable diffraction grating 16 so that a portion of the light can be directed to an eyepiece or video camera to allow an operator to select the field of view of the apparatus 10.

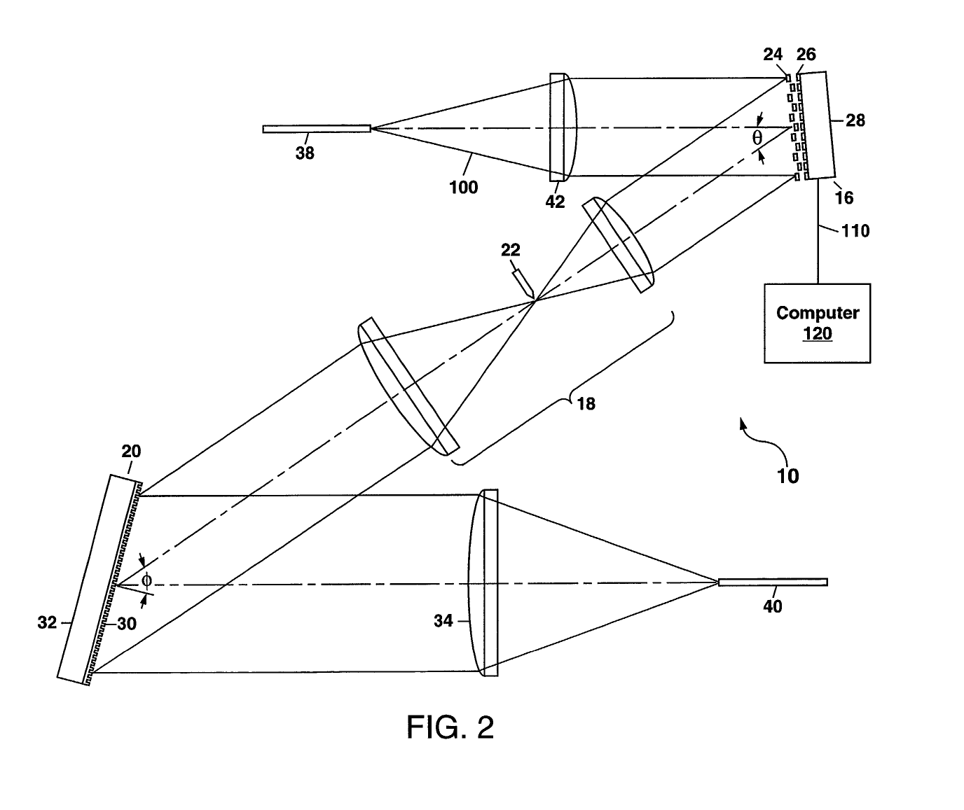

FIG. 2 schematically shows a second embodiment of the apparatus 10 of the present invention. The apparatus 10 in FIG. 2 is similar to that of FIG. 1 except the light 100 enters the apparatus 10 through an input optical fiber 38 and exits the apparatus 10 through an output optical fiber 40. This embodiment of the present invention has applications for use in optical fiber communications or optical interconnections where the apparatus 10 can be used to perform optical switching operations including optical multiplexing (also termed wavelength division multiplexing) and optical demultiplexing.

In FIG. 2, light 100 from the input optical fiber 38 containing a plurality of channels of optical communication at different wavelengths enters the apparatus 10 through a collimating lens 42 (e.g. a spherical or aspheric lens) which projects the light 100 onto the electrically-programmable diffraction grating 16. Electrical signals 110 are provided to the electrically-programmable diffraction grating 16 from a microprocessor or computer 120 to select a particular configuration of the grating elements 24 (i.e. a particular spaced relationship between the grating elements 24) that directs one or more wavelengths of the light 100 from the electrically-programmable diffraction grating 16 to the fixed diffraction grating 20 and therefrom through the focusing lens 34 and into the second optical fiber 40, with each wavelength of the light 100 corresponding to a channel of communication. In FIG. 2, the light 100 can be generated by one or more lasers.

To transfer or switch a single channel of optical communication (i.e. a single wavelength of the light 100) from the input optical fiber 38 to the output optical fiber 40, the grating 16 can be programmed, for example, as shown in FIG. 2 with every other grating element 24 activated and electrostatically pulled down towards its corresponding stationary electrode 26. This can be done by providing an electrical input signal 110 (i.e. a programming signal) generated by a voltage source, a microprocessor or a computer 120 to every other grating element 24. Such switching can perform a demultiplexing operation by processing the light 100 to select a single channel of optical communication from the input fiber 38 and to direct that channel of communication to the exit fiber 40.

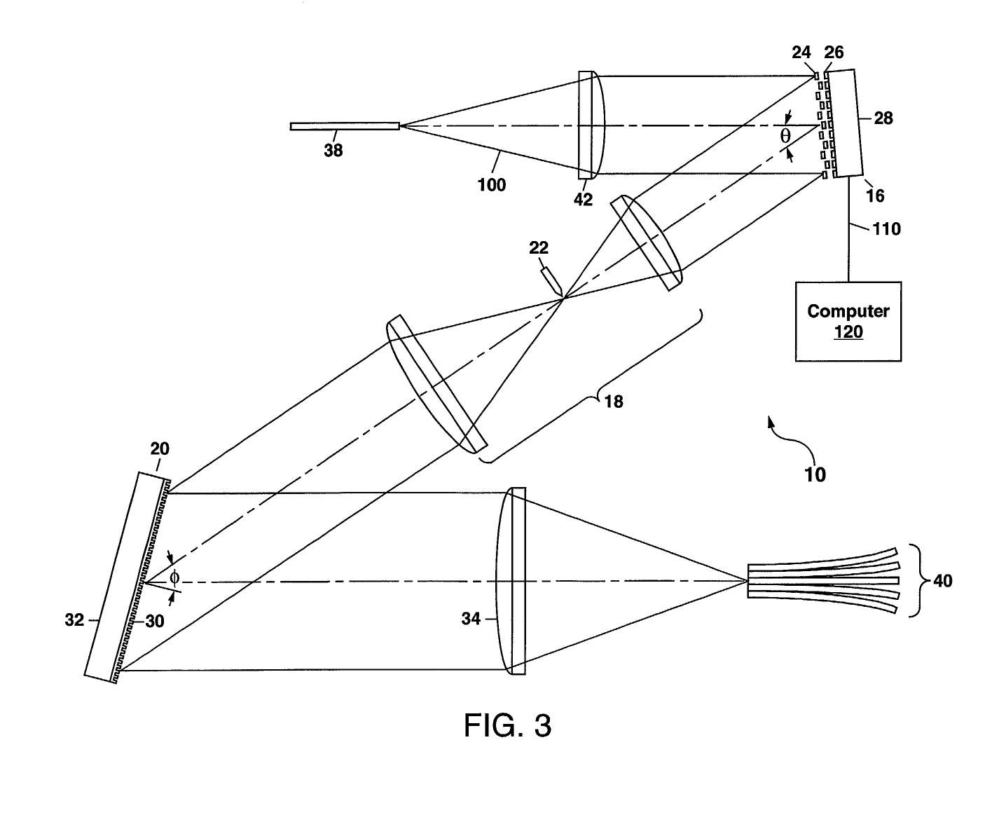

Alternately, as shown in a third embodiment of the present invention in FIG. 3, a plurality of output fibers 40 can be substituted for the single output fiber 40 shown in FIG. 2. The apparatus 10 can then be used to process the light 100 from the input fiber 38 and select a plurality of wavelengths, λ₁, λ₂ . . . λₙ, of the light 100 that are then spatially separated according to wavelength so that the individual wavelengths, λ₁, λ₂ . . . λₙ Of the light 100 can be directed to different output fibers 40. Thus, the apparatus can form an optical demultiplexer. With the electrically-programmable diffraction grating 16 operating to provide a singly-periodic spaced arrangement of the grating elements 24, the wavelengths, λ₁, λ₂ . . . λₙ, of the light 100 can be spatially separated according to wavelength so that channels of communication having adjacent wavelengths can be directed to adjacent output fibers 40 (i.e. each wavelength of light will have a different focal point at the location of a different output fiber 40 after passing through the focusing lens 34).

However, with the electrically-programmable diffraction grating 16 operating in a multiply-periodic spaced arrangement of the grating elements 24, the spatial arrangement of the individual wavelengths, λ₁, λ₂ . . . λₙ, can be altered so that selected wavelengths (e.g. λ₁, and λ₂) of the light 100 can be directed to a particular output fiber 40, while the remaining wavelengths of the light 100 are either blocked (e.g. by optical stop 22) or else directed to other of the output fibers 40. This can allow switching of particular wavelengths of the light 100 from the input fiber 38 to a particular output fiber 40 as determined by a plurality of computer-generated programming voltages 110 applied between the grating elements 24 and associated stationary electrodes 26 of the electrically-programmable diffraction grating 16.

For light 100 transmitted through the apparatus 10 in the reverse direction (i.e. from the fibers 40 to the fiber 38), the apparatus 10 can operate as an optical multiplexer to direct a plurality of wavelengths, λ₁, λ₂ . . . λₙ, Of light from different optical fibers 40 into a single light beam 100 which can be coupled into a single optical fiber 38. Alternately, one or more wavelengths of light can be directed from a selected source fiber 40 into the single optical fiber 38, with the exact source fiber 40 being switchable over time in response to programming of the electrically-programmable diffraction grating 16. For optical multiplexing and demultiplexing, the ends of the plurality of optical fibers 40 can be arranged as a 1×n array in a direction normal to the longitudinal axis of the grating elements 24 and 30 as shown in FIG. 3.

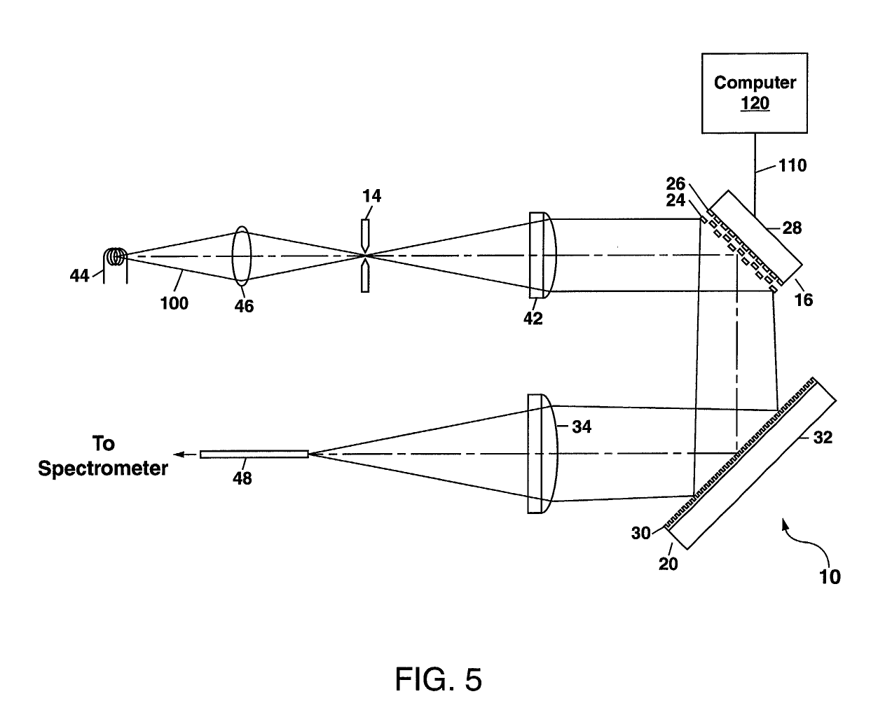

In other embodiments of the present invention, the telescope 18 between the electrically-programmable diffraction grating 16 and the fixed diffraction grating 20 can be omitted, although this can result in some loss of light throughput or degradation in the performance of the apparatus 10 since the two gratings 16 and 20 will not be precisely imaged on each other. FIG. 5 shows a fourth embodiment of the present invention in which the telescope 18 has been omitted. This fourth embodiment of the apparatus 10 of the present invention has been used to experimentally verify operation of the electrically-programmable diffraction grating 16 and the fixed diffraction grating 20 operating in tandem.

In FIG. 5, white light 100 from a tungsten lamp 44 was focused onto a slit 14 using a focusing lens 46. Another lens 42 then collimated the light 100 and directed the light 100 to an electrically-programmable diffraction grating 16 which was oriented at a 45° angle to the incident light 100. The grating 16 directed the light 100 to a fixed diffraction grating 20 which was located about ten inches away. A first-order diffraction component of the light 100 thus impinged on the fixed diffraction grating 20 which had a fixed spatial frequency of 295 lines/mm. The spatial frequency of the electrically-programmable diffraction grating 16 operating with a singly-periodic spaced relationship of the grating elements 24 could be varied between 0 lines/mm and about 41 lines/mm with appropriate electrical programming of the grating elements 24. Alternately, the grating elements 24 can be programmed to provide a multi-periodic spaced relationship as described previously. The light 100 after being diffracted off the fixed diffraction grating 20 was directed by a focusing lens 34 into a multi-mode optical fiber 48 having a 100 μm diameter core. This fiber 48 conveyed the light 100 to the input of a spectrometer (not shown) where the wavelength of the light 100 was analyzed.

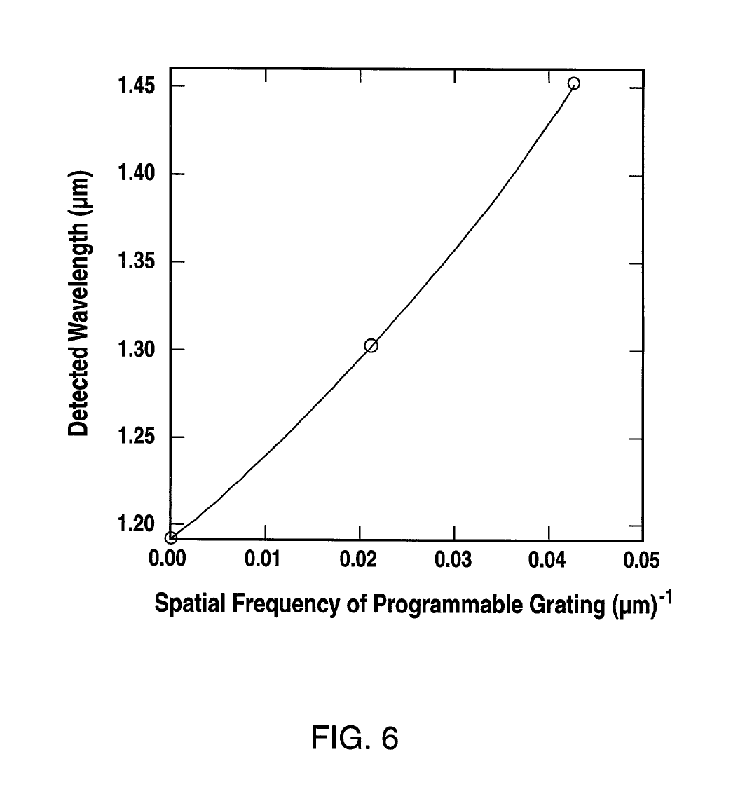

FIG. 6 graphically illustrates the results of these measurements with the measured data points indicated as open circles. Without any voltages to the electrically-programmable diffraction grating 16, a detected component of the light 100 was in the form of a narrow band of light centered at about 1.19 μm with a bandwidth of 8 nanometers full-width at half maximum. This detected light component was determined by the diffraction characteristics of the fixed diffraction grating 20 and the location of the fiber 48 since, in this mode, the electrically-programmable diffraction grating 16 did not diffract the light 100 but simply acted as a mirror to deflect the light 100 to the fixed diffraction grating 20.

By activating the electrically-programmable diffraction grating 16 to pull down every other pair of grating elements 24, a singly-periodic diffraction grating with a pitch of 48 μm (i.e. a spatial frequency of 0.0208 μm⁻¹ or 20.8 lines/mm) could be produced which acted in combination with the fixed diffraction grating 20 to direct a different wavelength component centered about 1.30 μm into the optical fiber 48 while blocking all other wavelengths from the white light source 44. When the electrically-programmable diffraction grating was activated to pull down every other grating element 24, the resultant pitch was 24 μm (i.e. a spatial frequency of 0.0417 μm⁻¹ or 41.7 lines/mm) which transmitted yet another wavelength component of the light 100 centered at about 1.45 μm into the optical fiber 48 while blocking all the remaining wavelengths from the white light source 44. Although not shown in FIG. 6, additional combinations of the grating elements 24 for the singly-periodic grating 16 can be formed in a similar manner (e.g. by pulling down every other set of n grating elements 24 where n=3, 4, 5 . . .).

These results, shown in FIG. 6 with the detected wavelength plotted as a function of the spatial frequency of the electrically-programmable diffraction grating 16, illustrate how the apparatus 10 of the present invention can be used to process the light 100 and select a particular wavelength, λ, for analysis or detection. The solid line in FIG. 6 represents a calculation using the equation:

$$λ = \frac{[ sin {α ( 1 - {η}^{2} )}^{\frac{1}{2}} - η cos α - sin {θ}_{i} ]}{ξ}$$

where ξ is the spatial frequency of the electrically-programmable diffraction grating 16, α is related to the angle between the normals of the gratings 16 and 20, θᵢ is the angle of incidence of the light 100 on the electrically-programmable diffraction grating 16, and η is defined as:

η=sinφ₀λξ₀

where φ₀ is the diffraction angle of the light 100 off the fixed diffraction grating 20 and ξ₀ is the spatial frequency of the grating 20. This calculation shows excellent agreement with the measured data points in FIG. 6.

Although the results in FIG. 6 were produced by configuring the electrically-programmable diffraction grating 16 as a singly-periodic grating, it is also possible to configure the grating 16 as a multiply-periodic grating as described previously. This can be useful for defining other values of the spatial frequency ξ to select a particular wavelength, λ, from the light 100 being processed with the apparatus 10. The use of a multiply-periodic spaced arrangement of the grating elements 24 in the electrically-programmable diffraction grating 16 can also be used to select multiple wavelength components (i.e. multiple wavelengths of the light 100) for transmission through the apparatus 10 (e.g. for directing these multiple wavelength components to the optical fiber 48 in FIG. 5, or to a particular output fiber 40 as in FIGS. 2 and 3, or to a detector 36 as in FIG. 1).

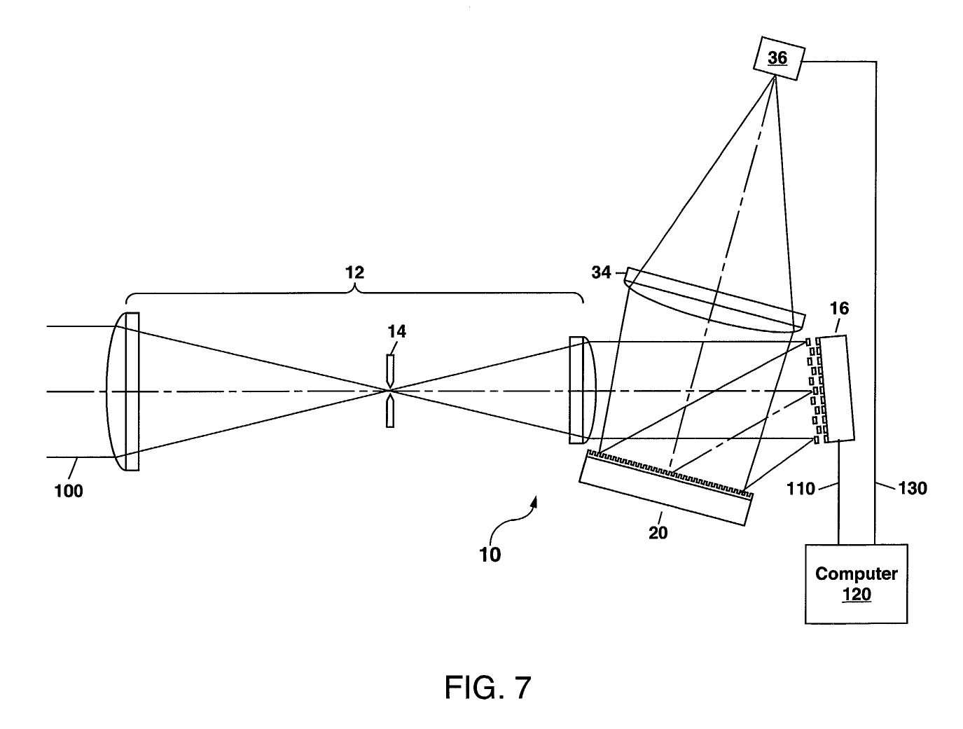

Those skilled in that art will understand that the exact orientation of the electrically-programmable diffraction grating 16 and the fixed diffraction grating 20 will depend upon the angle of incidence of the light 100, and whether or not the fixed diffraction grating 20 is blazed at a particular angle. Thus, for example, an arrangement like that shown in FIG. 7 is possible when the apparatus 10 of FIG. 5 utilizes a blazed diffraction grating 20 and is configured for remote vapor detection as in FIG. 1, but without the telescope 18.

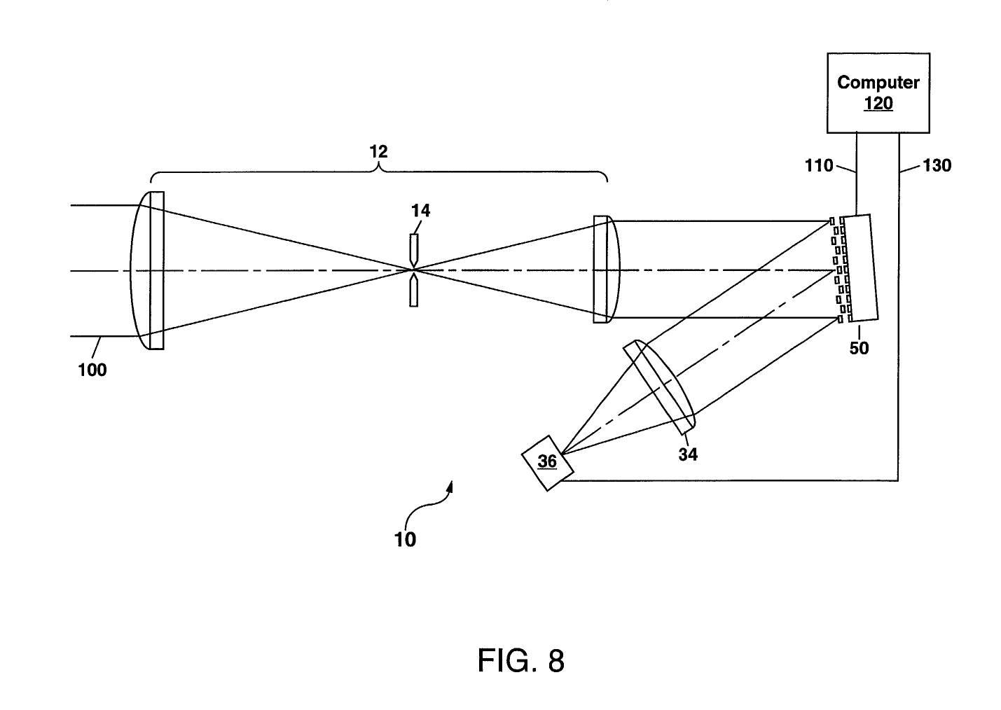

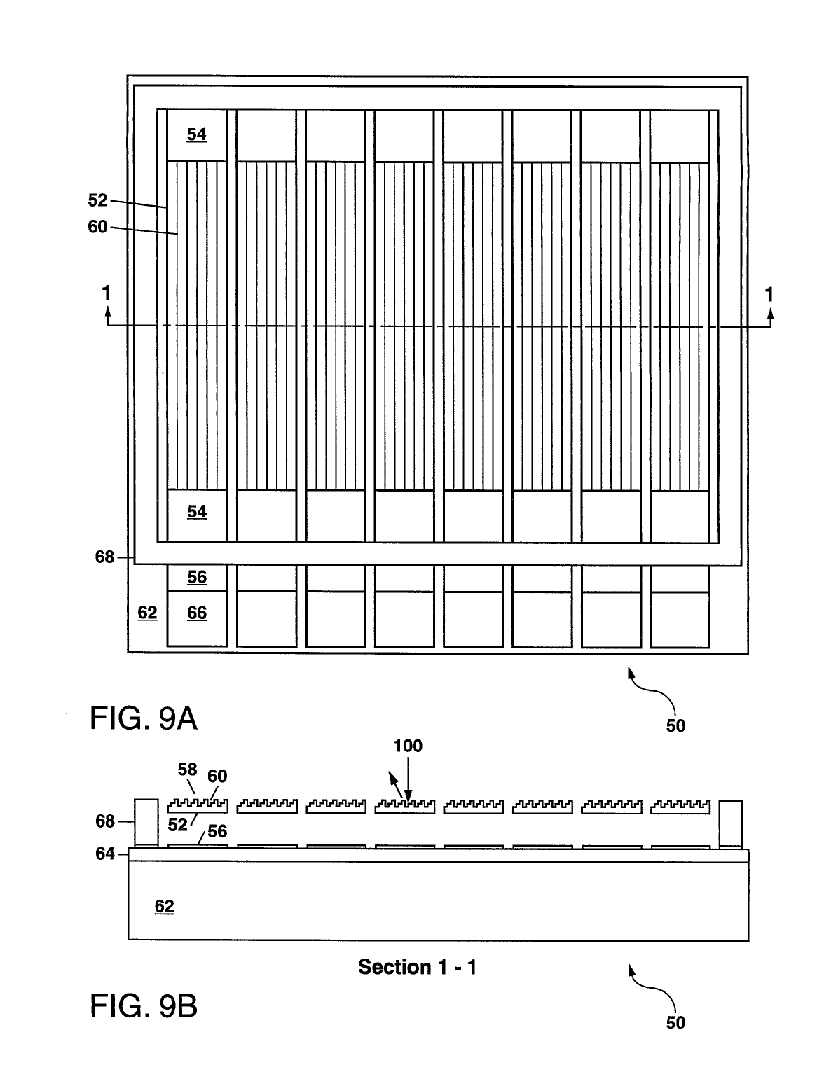

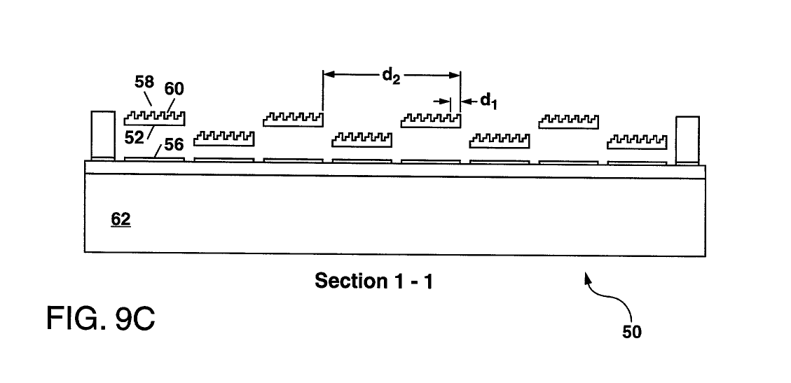

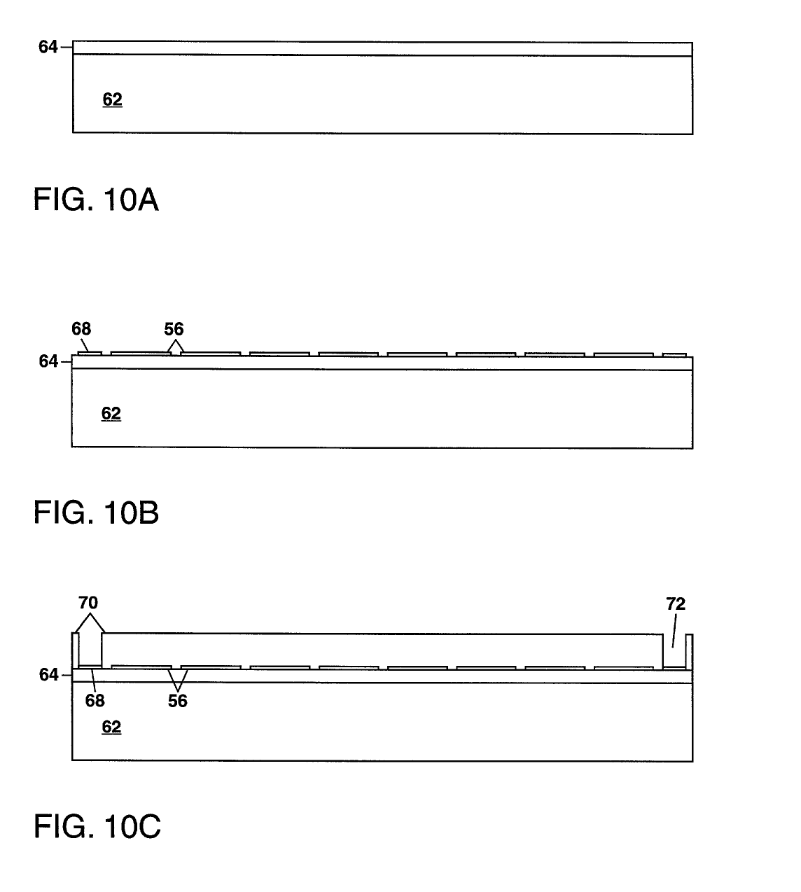

FIG. 8 shows a fifth embodiment of optical apparatus 10 of the present invention. In this embodiment of the apparatus 10, the electrically-programmable diffraction grating 16 and the fixed diffraction grating 20 of FIGS. 5 and 7 have been combined on a single substrate, thereby forming a composite diffraction grating 50 which can perform the combined functions of the two gratings 16 and 20. Details of the composite diffraction grating 50 are shown in the schematic plan view of FIG. 9A and in the schematic cross-section view of FIG. 9B.

In FIGS. 9A and 9B, the composite grating 50 comprises a plurality of electrostatically moveable elongate grating elements 52, with each grating element 52 being. supported at the ends thereof by a flexible spring 54 above a stationary electrode 56 so that so that the spaced relationship of each grating element 52 with respect to the remaining grating elements can be electrically varied in response to a programming voltage provided between that grating element 52 and its associated underlying stationary electrode 56. A fixed diffraction grating 58 comprising a plurality of parallel lines or grooves 60 in a fixed spaced relationship with respect to each other is formed on a top surface of each grating element 52.

In the absence of any voltage applied between the grating elements 52 and the stationary electrodes 56, the plurality of grating elements 52 as fabricated are coplanar as shown in FIG. 9B so that incident light 100 is diffracted off the grooves 60 as in the fixed diffraction grating 20 described previously. When programming voltages are applied between selected of the grating elements 52 and their associated stationary electrodes 56, these grating elements 52 will be electrostatically pulled down towards their associated stationary electrodes 56 to an extent that depends upon the exact value of the programming voltages 110 or a mechanical stop (not shown) located below the grating elements 52.

Two modes of operation of the moveable grating elements 52 are possible. In a first mode of operation schematically illustrated in the cross-section view of FIG. 9C, every nth grating element 52 is pulled down where n=1, 2, 3 . . . . In this mode of operation, the composite diffraction grating 50 behaves as the superposition of the fixed diffraction grating 58 of periodicity, d₁, between adjacent grooves 60 and another diffraction grating of periodicity, d₂, as determined by the number, n, of adjacent grating elements 52 which are pulled down as a group and the same number, n, of adjoining-grating elements 52 which are left in their original position. In a second mode of operation similar to that schematically illustrated in FIG. 4, a multiperiodic spaced relationship between the grating elements 52 can be formed so that the composite diffraction grating 50 behaves as the superposition of the fixed diffraction grating 58 with a multiperiodic diffraction grating formed by the grating elements 52.

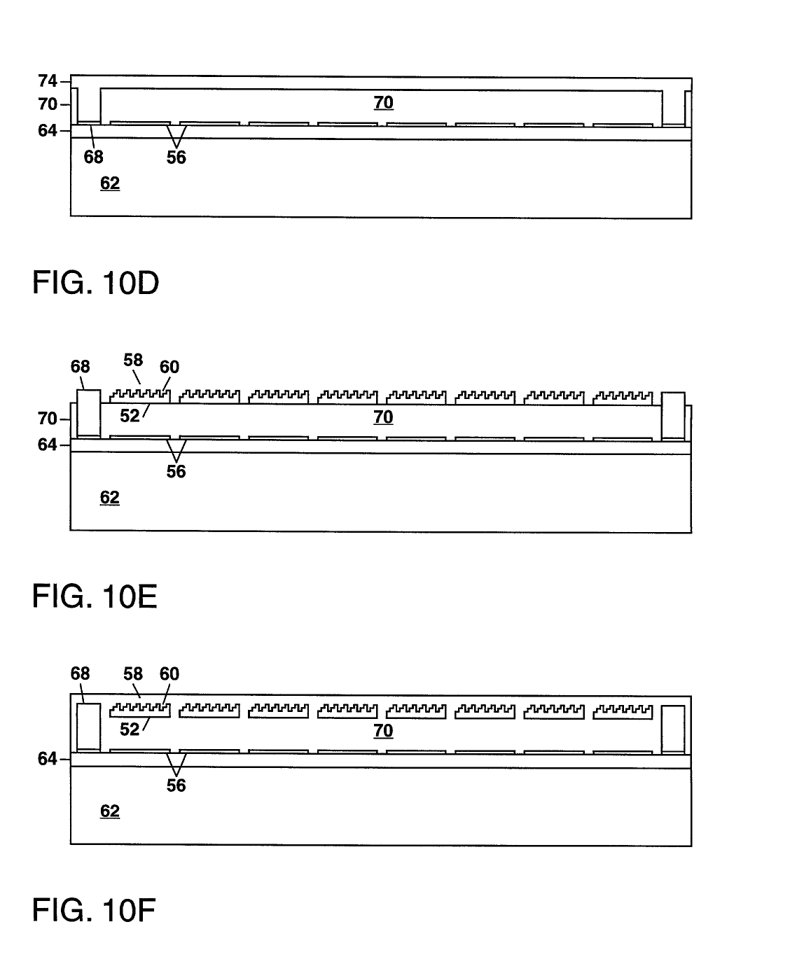

The composite diffraction grating 50 can be fabricated, for example, using surface micromachining as described hereinafter with reference to FIGS. 10A -10F. Surface micromachining is based on repeated deposition and patterning of polycrystalline silicon (also termed polysilicon) and a sacrificial material (e.g. silicon dioxide or a silicate glass). The term “patterning” as used herein refers to a sequence of well-known integrated circuit (IC) processing steps including applying a photoresist to a substrate, prebaking the photoresist, aligning the substrate to a photomask (also termed a reticle), exposing the photoresist through the photomask, developing the photoresist, baking the wafer, etching away the surfaces not protected by the photoresist, and stripping the protected areas of the photoresist so that further processing can take place. The term “patterning” can further include the formation of a hard mask (e.g. comprising about 500 nanometers of a silicate glass deposited from the decomposition of tetraethylortho silicate, also termed TEOS, by low-pressure chemical vapor deposition at about 750° C. and densified by a high temperature processing) overlying a polysilicon or sacrificial material layer in preparation for defining features into the layer by etching.

In FIG. 10A, a substrate 62 is provided to begin the process of fabricating the composite diffraction grating 50. The substrate 62 generally comprises silicon (e.g. a silicon or silicon-on-oxide wafer or portion thereof) although other types of substrates 62 can be used (e.g. comprising glass, quartz, fused silica, ceramic, or metal). The substrate 62 can be either electrically conducting or electrically insulating. An electrically-insulating layer 64 can be formed over the substrate 62 to electrically isolate the stationary electrodes 56 from the substrate 62. For a silicon substrate 62, this can be done by forming a layer of thermal oxide (e.g. about 0.6 μm thick) on exposed surfaces of the substrate 62 followed by deposition of a low-stress layer of silicon nitride. The thermal oxide layer can be formed using a conventional wet oxidation process at an elevated temperature (e.g. 1050° C. for about 1.5 hours). The silicon nitride layer (e.g. 0.8 μm thick) can be conformally deposited using low-pressure chemical vapor deposition (LPCVD) at about 850° C.

In FIG. 10B, a first layer of polysilicon can be blanket deposited over the substrate 62 to a layer thickness of about 0.3 μm using LPCVD at about 580° C. The first polysilicon layer, which is doped with phosphorous to increase its electrical conductivity, can then be patterned by photolithographic definition and etching (e.g. reactive ion etching) to form the stationary electrodes 56 and any necessary wiring for connecting the stationary electrodes 56 to a plurality of bond pads 66 so that the programming voltage can be provided between one or more of the grating elements 52 and associated stationary electrodes 56. This first polysilicon layer can also be used to begin to built up a frame 68 for supporting the grating elements 52 and for providing the electrical connection to the grating elements 52 which are all generally electrically connected together and held at ground electrical potential. When the substrate 62 is electrically conducting, one or more vias (not shown) can be optionally etched through the insulating layer 64 to the substrate 62 so that the frame 68 can be electrically connected to the substrate 62. After deposition and patterning, the first polysilicon layer can be annealed at a high temperature (e.g. at about 1100° C. for three hours) to reduce any stress therein. Each subsequently-deposited polysilicon layer can be similarly deposited and annealed after patterning thereof.

In FIG. 10C, one or more layers of a sacrificial material 70 are deposited over the substrate 62 by LPCVD to a total thickness of a few microns (e.g. 2-10 μm), with the exact thickness of the sacrificial material 70 depending upon a maximum wavelength of light 100 with which the composite diffraction grating 50 is to be used. The sacrificial material 70 can comprise silicon dioxide or a silicate glass such as TEOS which is removable using a selective etchant that does not attack the polysilicon layers. Each deposited layer of the sacrificial material 70 can be about 1-2 μm thick. After deposition, the sacrificial material 36 can be planarized, for example, using chemical-mechanical polishing (CMP) as disclosed in U.S. Pat. No. 5,804,084 which is incorporated herein by reference.

After planarization of the sacrificial material 70, an annular trench 72 can be etched through the sacrificial material 70 down to the frame 68 which is being built up by successive deposition and patterning of polysilicon. The trench 72 can be etched using reactive ion etching using a patterned hard mask comprising TEOS.

In FIG. 10D, one or more layers 74 of polysilicon can be blanket deposited by LPCVD over the sacrificial material 70 and in the trench 72 to further build up the frame 68, and to be used to form the grating elements 52 and the supporting springs 54. Each polysilicon layer can be 1-2 μm thick; and the exact number and overall thickness of the polysilicon layers 74 will depend upon the vertical extent of motion of the grating elements 52, which in turn depends upon a wavelength range of interest (e.g. 1-10 μm). Additionally, the exact number and overall thickness of the polysilicon layers 74 will depend upon the lateral dimensions (e.g. about 10-100 μm wide and 0.1-10 mm long) of the grating elements 52 in order to limit vertical or horizontal sagging of the grating elements 52. Once these polysilicon layer(s) 74 have been deposited, they can be planarized by CMP, if needed.

In FIG. 10E, an exposed upper surface of the polysilicon layers 74 can be patterned by photolithographic masking and reactive ion etching to form the grooves 60, the springs 54, the grating elements 52 and the frame 68. A single masking and reactive ion etching step can be used to form the grooves 60 as uniform depth trenches, thereby forming the fixed diffraction grating 58 with a square grating profile. Additional masking and reactive ion etching steps can then be used to form the springs 54 and frame 68 and sidewalls of the grating elements 52, with the grooves 60 being protected by an etch mask. As shown in FIG. 10E, the grooves 60 can also be formed in a staircase pattern to form a blazed diffraction grating 58. This can be advantageous since it provides a higher efficiency for diffracting light. The staircase-shaped grooves can be formed using multiple (e.g. 2-3) masking and etching steps. An optional reflective coating can be deposited over the grooves 60, if needed, to further improve the diffraction efficiency.

In FIG. 10F, the springs 54 can be formed, for example, by thinning the polysilicon to a fraction (e.g. one-third or less) of the thickness of the grating elements 52 using reactive ion etching. Although the springs 54 are shown as flat springs having the same width as the grating elements 52, those skilled in the art will understand that other types of springs 54 can be used to suspend the grating elements 52 for translatory motion (see, for example, U.S. Pat. No. 5,757,536 which is incorporated herein by reference). In some embodiments of the present invention, a plurality of leaf springs 54 can be located underneath each grating element 52, with one end of each leaf spring 54 being connected to the bottom of the grating element 52 and with the other end of each leaf spring 54 being connected to the substrate 62, or to a support formed on the substrate 62.

In FIG. 10F, additional sacrificial material 70 can be deposited over the substrate 62 to encapsulate the grating elements 70 so that a final annealing step can be performed to remove any stress from the grating elements 52, springs 54 and support frame 68. Once this annealing step has been performed, the sacrificial material 70 can be etched down to the first polysilicon layer at locations where the bond pads 66 are to be formed so that a metal (e.g. aluminum or tungsten, or an alloy thereof) can be deposited over the first polysilicon layer to form the bond pads 66. The bond pads 66 can then protected if necessary during a subsequent selective etching step which is used to remove the remainder of the sacrificial material 68. This etching step utilizes a solution comprising hydrofluoric acid (HF) to selectively etch away the sacrificial material 68 over a period of several hours while not substantially attacking other materials (e.g. polysilicon and silicon nitride) which are chemically resistant to the selective etchant. Once the sacrificial material 70 has been removed, formation of the composite diffraction grating 50 is complete as shown in FIGS. 9A and 9B.

Although the composite grating 50 has been described with the grating elements 52 being moveable in a direction perpendicular to the substrate 62, in other embodiments of the present invention, the grating elements 52 can be fabricated so at least a portion of the grating elements 52 are moveable in a direction parallel to the substrate 62, or alternately in a direction that has vector components both parallel to the substrate 62 and perpendicular to the substrate 62. Motion the grating elements 52 in a direction parallel to the substrate 62 can be performed, for example, by locating a stationary electrode 56 on one side of each grating element 52 so that a horizontally-directed electrostatic force of attraction can be generated when a voltage is applied between the stationary electrode 56 and the grating element 52. Each grating element 52 can be, for example, T-shaped with the stationary electrode 56 extending upward from the substrate 62 and parallel to a vertically-oriented leg of the T-shaped stationary electrode 56. As another example, the stationary electrode 56 can be formed similarly to the grating element 52 with a plurality of grating elements 60 formed on an upper surface thereof. In this case, the stationary electrode 56 would include a support or a plurality of legs to attach the stationary electrode 56 to the substrate 62 to prevent any motion of the stationary electrode 56 when a voltage is applied between the grating element 52 and the stationary electrode 56.

Motion of the grating elements 52 in a direction that includes components both horizontal and vertical to the substrate 62 can be performed, for example, by locating the stationary electrodes 56 underneath the grating elements 52 as shown in FIG. 9B, and utilizing a plurality of leaf springs 54 connected between the bottom of each grating element 52 and the substrate 62, with the leaf springs 54 providing a hinged motion of the grating elements 52 in response to a voltage applied between the grating elements 52 and the underlying stationary electrodes 56.

Other applications and variations of the present invention will become evident to those skilled in the art. The matter set forth in the foregoing description and accompanying drawings is offered by way of illustration only and not as a limitation. The actual scope of the invention is intended to be defined in the following claims when viewed in their proper perspective based on the prior art.

What is claimed is:

1. An optical apparatus comprising a pair of diffraction gratings operable in tandem for processing light, the pair of diffraction gratings including a first diffraction grating having a first plurality of grating elements with a fixed spaced relationship therebetween, and a second diffraction grating having a second plurality of grating elements with an electrically-variable spaced relationship therebetween, one of the pair of diffraction gratings initially intercepting and processing the light and directing the light to the other of the pair of diffraction gratings for further processing.

2. The apparatus of claim 1 wherein the number of grating elements in the first plurality of grating elements is different from the number of grating elements in the second plurality of grating elements.

3. The apparatus of claim 1 wherein a spacing between adjacent grating elements in the first plurality of grating elements is different from the spacing between adjacent grating elements in the second plurality of grating elements.

4. The apparatus of claim 1 wherein the first diffraction grating comprises a replicated, ruled or holographic diffraction grating.

5. The apparatus of claim 1 wherein the second diffraction grating comprises an electrically-programmable diffraction grating in which the spaced relationship of the second plurality of grating elements can be varied in response to at least one electrical signal provided thereto.

6. The apparatus of claim 5 wherein each grating element in the second plurality of grating elements comprises an elongate moveable electrode elastically supported above an elongate stationary electrode to permit the spaced relationship of the grating element to be varied relative to an adjacent grating element in the second plurality of grating elements in response to the electrical signal applied between the stationary and moveable electrodes.

7. The apparatus of claim 5 further including a microprocessor or a computer for providing each electrical signal to the electrically-programmable diffraction grating.

8. The apparatus of claim 1 wherein each diffraction grating is formed on a separate substrate.

9. The apparatus of claim 8 wherein at least one of the substrates comprises silicon.

10. The apparatus of claim 1 further comprising a lens or telescope for receiving the light and directing the light onto the diffraction grating which initially intercepts and processes the light.

11. The apparatus of claim 10 further comprising a detector for receiving the processed light and generating an output signal therefrom.

12. The apparatus of claim 10 further comprising a telescope located in a path of the light between the two diffraction gratings.

13. The apparatus of claim 12 wherein the telescope substantially images the surface of one of the diffraction gratings onto the surface of the other diffraction grating.

14. The apparatus of claim 12 further comprising an optical stop located between the first and second diffraction gratings to further process the light by eliminating an unwanted component of the light.

15. The apparatus of claim 1 wherein the light is received from at least one input optical fiber, and at least a portion of the received light is further directed to at least one output optical fiber after processing thereof.

16. The apparatus of claim 1 wherein the electrically-variable spaced relationship of the second plurality of grating elements is a singly-periodic spaced relationship.

17. The apparatus of claim 1 wherein the electrically-variable spaced relationship of the second plurality of grating elements is a multiply-periodic spaced relationship.

18. An optical apparatus for processing light, comprising:
(a) a first substrate having a fixed diffraction grating formed thereon, with the fixed diffraction grating further comprising a plurality of fixed grating elements; and
(b) a second substrate located proximate to the first substrate and having an electrically-programmable diffraction grating formed thereon, with the electrically-programmable diffraction grating further comprising a plurality of moveable grating elements, and with each moveable grating element being elongate and elastically mounted for movement relative to an adjacent grating element in response to a voltage applied between the grating element and an electrode formed proximate thereto, the fixed and electrically-programmable diffraction gratings operating in combination to sequentially process the light.

19. The apparatus of claim 18 further comprising an optical stop located between the two diffraction gratings to further process the light by eliminating an unwanted component of the light.

20. The apparatus of claim 18 wherein the fixed diffraction grating comprises a replicated, ruled or holographic diffraction grating.

21. The apparatus of claim 18 wherein the fixed diffraction grating and the electrically-programmable diffraction grating have a different number of grating elements therein.

22. The apparatus of claim 18 wherein the fixed diffraction grating and the electrically-programmable diffraction grating have a different spacing between adjacent grating elements.

23. The apparatus of claim 18 wherein the first and second substrate comprise different substrate materials.

24. The apparatus of claim 18 further comprising a lens or telescope for receiving the light and directing the light onto the diffraction grating which initially processes the light.

25. The apparatus of claim 24 further comprising a detector for receiving the processed light and generating an output signal therefrom.

26. The apparatus of claim 24 further comprising a telescope located in a path of the light between the two diffraction gratings.

27. The apparatus of claim 18 wherein the light is directed onto the diffraction grating which initially processes the light from at least one input optical fiber, and is further directed to at least one output optical fiber after processing thereof.

28. An optical apparatus for processing light, comprising a composite diffraction grating formed on a substrate and having a first plurality of grating elements with an electrically-variable spaced relationship between adjacent grating elements of the first plurality of grating elements, and with each grating element in the first plurality of grating elements further having formed thereon a second plurality of grating elements in a fixed spaced relationship between adjacent grating elements of the second plurality of grating elements.

29. The apparatus of claim 28 wherein the substrate comprises silicon.

30. The apparatus of claim 28 further comprising a lens or telescope for receiving the light and directing the light onto the composite diffraction grating.

31. The apparatus of claim 30 further comprising a detector for receiving the processed light and generating an output signal therefrom.

32. The apparatus of claim 28 wherein the light is received from at least one input optical fiber, and at least a portion of the received light is further directed to at least one output optical fiber after processing thereof.

33. The apparatus of claim 28 wherein at least a portion of the first plurality of grating elements are moveable in a direction perpendicular to the substrate for defining the electrically-variable spaced relationship between adjacent grating elements of the first plurality of grating elements.

34. The apparatus of claim 28 wherein at least a portion of the first plurality of grating elements are moveable in a direction parallel to the substrate for defining the electrically-variable spaced relationship between adjacent grating elements of the first plurality of grating elements.

35. A method for increasing the wavelength resolution of an electrically-programmable diffraction grating, comprising introducing a wavelength dispersing element into an optical path of the electrically-programmable diffraction grating.

36. The method of claim 35 wherein the wavelength dispersing element comprises a fixed diffraction grating.

37. A method for processing light comprising steps for:
(a) directing the light to a first diffraction grating for initial processing of the light by selecting a wavelength range of interest; and
(b) directing the light to a second diffraction grating for subsequent processing of the light by selecting at least one wavelength within the wavelength range of interest, with one of the first and second diffraction gratings having a fixed spaced relationship of grating elements therein, and with the other diffraction grating having an electrically-variable spaced relationship of grating elements therein.
